(19) United States
(12) Patent Application Publication
(10) Pub. No.: US 2007/0273467 A1
(43) Pub. Date: Nov. 29, 2007

(54) Magnet Core, Methods For Its Production And Residual Current Device

(76) Inventors: Jorg Petzold, Kahl (DE); Markus Brunner, Bessenbach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/752,745

(22) Filed: May 23, 2007

Related U.S. Application Data
(60) Provisional application No. 60/803,002, filed on May 23, 2006.

(51) Int. Cl. H01F 27/24

(52) U.S. Cl. 336/234; 335/295

(57) ABSTRACT

A magnet core wound from a soft magnetic strip is required to have a relative permeability μᵣ which is enhanced by reducing mechanical stresses. For this purpose, the soft magnetic strip is coated with a static friction reducing material on at least one side. This is at least partially burned off during the heat treatment of the magnet core. Its annealing residue is left behind, so that layers of soft magnetic material alternate with layers of the annealing residue of a static friction reducing material in the cross-section of the magnet core.

### CROSS-REFERENCE TO RELATED APPLICATIONS

This application claims the benefit of U.S. Provisional Application Ser. No. 60/803,002 filed May 23, 2006, which is incorporated herein by reference in its entirety.

### TECHNICAL FIELD

The invention relates to a magnet core wound using a soft magnetic strip. It further relates to a method for the production of a magnet core of this type and to a residual current device (RCD) with a magnet core.

### BACKGROUND

Magnet cores produced from spirally wound metal strip, so-called ring strip cores, are used in applications, such as current transformers, power transformers, current-compensated suppressor chokes, starting current limiters, storage chokes, single-conductor chokes, transductor chokes and total and differential current converters for RCDs.

Their magnetic properties are subject to stringent requirements: Current transformers for AC-sensitive RCDs, for example, have to provide a secondary voltage which is at least sufficient to trigger the magnetic system of the release relay responsible for disconnection. As the current transformer should be designed to save as much space as possible, the material used for the magnet core has to be characterised, in addition to high flux density at the typical operating frequency of 50 Hz, in particular by a very high relative permeability μᵣ. The most important factors affecting relative permeability are the geometry of the magnet core and its material properties in combination with the technical processing of the material, for example by heat treatment.

Up to now, a sufficiently high relative permeability could only be achieved by means of minimising the saturation magnetostriction constant λ_{S} to |λ_{S}|<2 ppm or even <0.3 ppm. In addition, it was essential to use strip which was geometrically as perfect as possible, with a minimum of defects of form. Such a low saturation magnetostriction constant λ_{S} can however only be obtained easily with very few alloys, and in industrial processes, it is virtually impossible to achieve an alloy with a precise composition without any impurities.

It would, however, be possible to obtain a high relative permeability with numerous other alloy compositions if the magnet core were free of mechanical stresses. Mechanical stresses can be introduced into the magnet core while it is being wound from one or more strips and/or during a subsequent heat treatment. The relationship between a stress-free magnet core and a high relative permeability is discussed in publications such as JP 63-115313.

From US 2005/0221126 A1, a method is known for deliberately introducing stresses into strip cores in order to improve their magnetic properties for high-frequency applications.

### SUMMARY

A magnet core wound using a soft magnetic strip with a relative permeability μᵣ increased by reducing mechanical stresses can be provided. A method for the production of a magnet core of this type can also be provided.

According to an embodiment, a magnet core can be produced from a spirally wound, soft magnetic strip, wherein the soft magnetic strip is provided at least on one side with a layer of the annealing residue of a static friction reducing material, so that layers of soft magnetic material alternate with layers of the annealing residue of a static friction reducing material in the cross-section of the magnet core.

According to another embodiment, a method for the production of a magnet core, may comprise the steps of provision of an amorphous, soft magnetic strip; coating of the strip with a static friction reducing material; winding of the strip to form a magnet core; and heat treatment of the magnet core.

According to yet another embodiment a method for the production of a magnet core, may comprise the steps of provision of an amorphous, soft magnetic strip; winding of the strip to form a magnet core; coating of the strip layers representing the magnet core with a static friction reducing material; and heat treatment of the magnet core.

### BRIEF DESCRIPTION OF THE DRAWINGS

Embodiments of the invention are explained in greater detail below with reference to the accompanying figures, of which:

FIG. 1 is a diagrammatic cross-section through a magnetic ring strip core;

FIG. 2a is a diagram of a section comprising a plurality of strip layers of the ring strip core following a first step of a method according to an embodiment;

FIG. 2b shows the same section after a next step of the method;

FIG. 2c shows the same section after a further step of the method; and

FIG. 3 is a table listing various embodiments of the method.

Identical components are identified by the same reference numbers in all figures.

### DETAILED DESCRIPTION

The embodiments disclosed are based on the principle that mechanical stresses introduced into the magnet core in the winding process or during the subsequent heat treatment are caused by the less than ideal strip form of the soft magnetic strip. Essentially, there are two types of deviation from the ideal form:

On the one hand, the surface of the soft magnetic strip is often not perfectly smooth, but has some degree of surface roughness. This surface roughness is contained within the micro- and nanoscale range and is subject to some variation in the mass production of the strip by casting in a quick solidification process. It may vary both between individual batches and within one and the same batch as a result of the wear of the casting wheel in the course of a production run. Ideally, the surface roughness Ra according to DIN 4762 or ISO 4287/1, measured as the arithmetic mean of the two strip sides (Ra₁+Ra₂)/strip thickness, has a value around 1%. Values between 2% and 6%, however, are typical, and very high values around 15% are possible.

On the other hand, mass production does not result in an ideal geometry of the strip with precisely plane-parallel surfaces, but in deviations from this geometry in the form of thickening or a wedge or bone shape of the strip.

These deviations from the ideal strip geometry result in local or whole-layer strains in the magnet core, which are generated in the winding process by local or planar thickness variations or peak-to-valley height variations in the individual strip layers. At the same time, geometrical surface defects result in the mutual hooking of the strip layers, preventing mechanical stress relief in the heat treatment process. The virtually ever-present combination of surface roughness and large-area form defects results in very high surface pressures at the points of contact between the strip layers and therefore to very high local static friction. Owing to the basic relation

$${μ}_{r} ∝ \frac{1}{{λ}_{s} \cdot σ}$$

between relative permeability μᵣ, the saturation magnetostriction constant λ_{S} and the mechanical stress σ, such strains result in a low and moreover highly scattered relative permeability at an insufficiently low saturation magnetostriction constant.

According to an embodiment, micro- and nanoscale deviations from ideal geometry resulting in the mutual hooking of the strip layers and thus in distortions in the magnet core are to be compensated by introducing a static friction reducing material between the individual strip layers. This may be done before or after the winding of the magnet core, should however be done before heat treatment. After the heat treatment, at least the annealing residue of the static friction reducing material remains in the magnet core, while the annealing loss is burned off, at least at a sufficient duration of the heat treatment.

The finished magnet core, i.e. the magnet core after heat treatment, typically comprises a nanocrystalline strip. Depending on the application of the magnet core, however, amorphous or crystalline strip types can conceivably be used.

Various alloy compositions are feasible for the magnet core according to an embodiment. As the saturation magnetostriction constant does not have to be completely eliminated, commercial iron based alloys can be used, and even residual impurities, which usually cannot be avoided completely, can be tolerated without undesirable effects on magnetic properties.

In one embodiment, the soft magnetic strip substantially has the following composition:
FeₐCo_{b}CuₑSi_{d}BₑM_{f},
wherein M represents one or more of the elements V, Nb, Ta, Ti, Mo, W, Zr and Hf, a, b, c, d, e and f are specified in atomic percent and 0≦b≦20; 0.5≦c≦2; 6.5≦d≦18; 5≦e≦14; 1≦f≦6; d+e>16 and a+b+c+d+e+f=100. Cobalt may be partially or wholly replaced by nickel.

The iron cross-sectional area A_{Fe} of the magnet core is defined by the formula

$${A}_{Fe} = \frac{{D}_{a} - {D}_{i}}{2} \cdot h \cdot η$$

wherein Dₐ is the outside diameter of the magnet core, Dᵢ its inside diameter, h the width of the strip and η the fill factor with 0%≦η≦100%, a typical value for magnet cores being η>40%.

Cavities between the strip layers, which are the inevitable result of the less than ideal strip geometry, reduce the iron cross-sectional area A_{Fe} of the magnet core. The fill factor to some degree is a measure of the strip's degree of deviation from the ideal, plane-parallel sheet.

In one embodiment, the heat-treated magnet core has a fill factor η of more than 80%, while in an alternative embodiment, the fill factor is 70%≦η≦80% or 65%≦η≦70%.

The effective peak-to-valley height RT of the strip expediently is 1%≦RT≦12% and even more expediently 1%≦RT≦6% or even 1%≦RT≦4%. The saturation magnetostriction constant λ_{S} of the magnet core is expediently less than 6 ppm, while the ratio between remanent and saturation flux density B_{R}/B_{S} is higher than 40%.

In one embodiment, the magnet core has a ratio between remanent and saturation flux density B_{R}/B_{S} of 1%≦B_{R}/B_{S}≦30%, in an alternative embodiment 30%≦B_{R}/B_{S}≦80% or 80%≦B_{R}/B_{S}≦97%.

Suitable static friction reducing materials include materials which can be applied as easily as possible, for example by spraying, roller-coating, deposition from a solution or gas phase or solid deposition from a suspension, and which reduce static friction between individual strip layers, thus generating a lubricating effect during the winding of the magnet core and the stress relief in the subsequent heat treatment process. A suitable static friction reducing material is, however, subject to further requirements. If possible, it should not form any distorting filmy layers or any distorting corrosion layers, which may for example happen with coatings of aluminium silicate, lithium silicate or magnesium oxide applied from an aqueous solution. The static friction reducing material should further not trigger any undesirable surface reactions or diffusion processes within the strip and should not cause any distorting shrinkage effects.

Suitable static friction reducing materials may include the following: nanodisperse SiO₂, commercially available for example under the trade name “Aerosil” or “HDK” and having a coefficient of thermal expansion similar to that of the strip, a magnesium methoxide solution, nanodisperse SiO₂ with magnesium methylate, pigment particles, carbon nano tubes, C₆₀ fullerene or zirconium propylate. In the use of these materials, corrosive surface attacks can be avoided by using non-aqueous solvents such as alcohols, ketones and ether alcohols.

A method according to an embodiment for the production of a magnet core comprises at least the following steps: an amorphous, soft magnetic strip, which may have been produced in a quick solidification process, is provided and coated with a static friction reducing material. The strip is then wound to form a magnet core, typically a ring strip core, whereupon the magnet core is subjected to heat treatment in order to obtain the desired magnetic properties. As an alternative, the coating process could follow the winding of the strip to form the magnet core, which could then be coated, for example in an economical process such as dip coating.

Both process variants permit the production of a magnet core which is largely free of mechanical stresses and can therefore have a high relative permeability. While the first variant avoids the stresses of conventional methods in the winding phase, these stresses are generally still present in the second variant. In the second variant, however, the stress relieving of the magnet core in the heat treatment process is made much easier by the static friction reducing material, so that this variant, too, provides a magnet core which is largely free of mechanical stresses.

In the method according to an embodiment, at least two stress relief mechanisms can be used either individually or in combination: either the loosening of the core by at least partially burning off the static friction reducing material in the heat treatment process, which offers the core enough freedom for stress relief, or a lubricating effect between the strip layers caused by the rolling or sliding characteristics of spherical, cylindrical or flaky particles or whole layers.

The method according to an embodiment can be used to obtain a hysteresis curve both in the shape of an F loop and in the shape of a Z or R loop. As the R loop in particular is aimed at maximum permeability values, however, the magnet core has to be especially low-stress to avoid interference anisotropies. For an R loop, the heat treatment is expediently performed field-free, i.e. in the absence of a magnetic field strong enough to have an adverse effect on the magnetic properties of the magnet core, and at a temperature T of 505° C.≦T≦600° C.

The static friction reducing material can for example be applied by deposition from the gas phase or from a solution, by deposition of solids from a suspension or in the sol gel process.

A surface coverage density ρ of the static friction reducing material of 10 mg/m²≦ρ≦600 mg/m² or preferably of 20 mg/m²≦ρ≦300 mg/m² or even 50 mg/m²≦ρ≦150 mg/m² is expediently achieved. This ensures on the one hand that static friction is sufficiently reduced and on the other hand that the static friction reducing material layer does not become too thick. If the layer is too thick, the magnet core, in the heat treatment process wherein a substantial portion of the static friction reducing material is burned off, loses too much of its fill factor and becomes too “loose” and thus too sensitive in subsequent handling.

The layer thickness d of the static friction reducing material prior to heat treatment is therefore d<5 μm, preferably d<1 μm or even d<0.5 μm or d<0.2 μm.

The method according to an embodiment offers the advantage that a magnet core with very favourable magnetic properties, in particular a high relative permeability, can be produced without too much engineering effort. The method avoids the dependence on special, often expensive, alloy compositions and makes the complete removal of impurities from the alloy unnecessary. At the same time, there is no need for complex selection processes in order to obtain as perfect a strip surface as possible. As a result, production costs for ring strip cores can be reduced in a very simple way by using the method according to an embodiment. In addition, as a result of the compensation of any faults in the strip, an undesirable excessive scatter of the permeability values can be avoided.

The magnet core according to an embodiment is particularly suitable for application in an RCD, because, owing to its high relative permeability, it provides a sufficiently high secondary voltage to trigger the magnet system of the release relay responsible for disconnection.

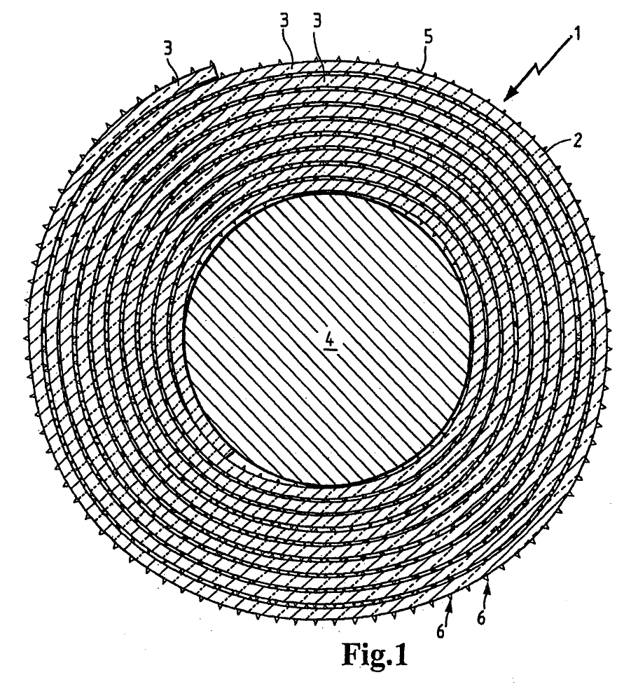

FIG. 1 is a cross-section through a magnet core 1, or more precisely through a ring strip core comprising a plurality of strip layers 3. The magnet core 1 is wound on a cylinder 4, which can later be removed, using a soft magnetic, typically amorphous, strip 2. The strip 2 does not have an ideal geometry with smooth, exactly plane-parallel surfaces 5. Its thickness varies locally, resulting in surface roughness, and the strip 2 may moreover have geometrical faults such as thickening or a wedge- or bone-shaped cross-sectional area. In FIG. 1, the surface roughness of the strip 2 is indicated by hooks 6.

As a result of the less than ideal geometry of the strip 2 caused by the hooks 6 and other irregularities, mechanical stresses are generated in the magnet core 1 in the winding process of the magnet core 1 owing to a static friction between individual strip layers 3, which is considerably higher than in an ideal strip. These mechanical stresses can be relieved in the heat treatment of the magnet core 1 following the winding process, but this is completely or at least partially prevented by the sustained mutual hooking of the strip layers 3.

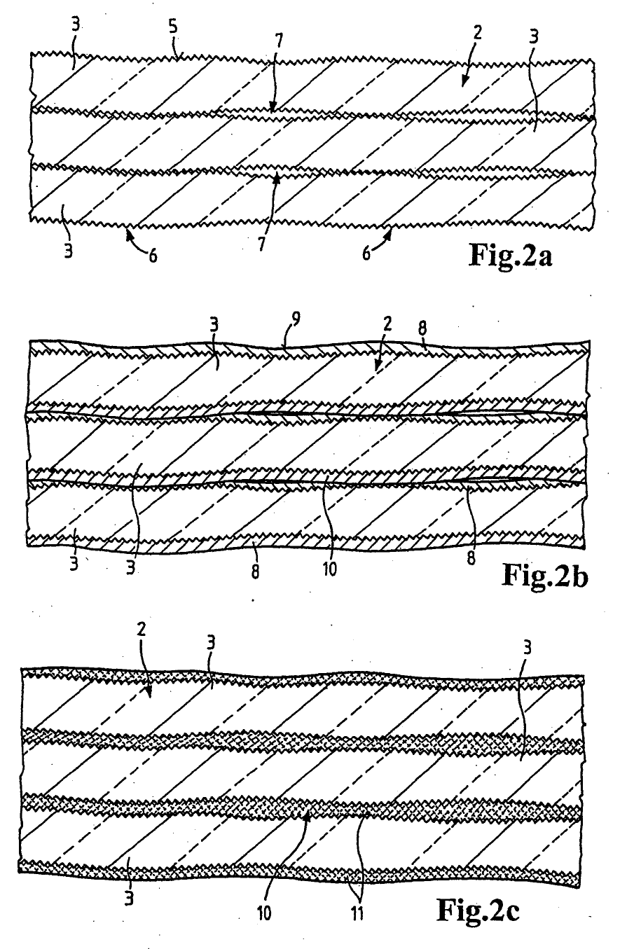

FIG. 2 illustrates steps of a method according to an embodiment for the production of a magnet core 1. In the illustrated variant of the method, the magnet core 1 is first wound, whereupon its strip layers 3 are coated with a static friction reducing material, for example by dip coating. It is, however, alternatively possible to coat the strip prior to winding, for example by dip coating or in a continuous process. The magnet core 1 is then subjected to a heat treatment, wherein the static friction reducing material is burned off completely or at least largely. The result is a stress-free magnet core 1 due both to a lubricating effect of the static friction reducing material and to a loosening of the magnet core by the partial burning-off of the static friction reducing material, enabling the magnet core 1 to relax during the heat treatment.

FIG. 2a shows a section of the wound magnet core with three strip layers 3 of the soft magnetic strip 2. In view of the high magnification and in order to simplify the illustration, the strip layers 3 are shown not curved but flat. The surface 5 of the strip 2 is not perfectly flat, but characterised by micro- and nanoscale geometry faults such as a surface roughness indicated by hooks 6. “Long wave” form faults along and across the strip direction are superimposed on these “short wave” oscillations. This results in cavities 7 forming in the magnet core between the strip layers 3 in the winding process, which are undesirable, because they reduce the iron cross-sectional area of the magnet core and cause mechanical stresses.

FIG. 2b shows the same magnet core section following the coating of the strip 2 with a static friction reducing material 8. The static friction reducing material 8 covers the strip 2, forming intermediate layers 10 between the strip layers 3, resulting in alternate layers of soft magnetic strip 2 and static friction reducing material 8. The new surface 9 of the strip 2 is significantly smoother than the original surface and therefore much more closely approaches an ideal surface. If the layer is built up from spherical or cylindrical particles or graphite layers, it has even now a noticeable lubricating effect, promoting the sliding of the strip layers and thus relieving the core.

After coating, the magnet core is subjected to heat treatment in a retort or tunnel furnace. As FIG. 2c indicates, the static friction reducing material is partially or largely burned off during this heat treatment. What remains is substantially the annealing residue 11 of the static friction reducing material, which now forms the intermediate layers 10 between the strip layers 3. The material loss caused by this process results in a loosening of the magnet core. If the annealing residue moreover has the lubricating effect described above, these two basic mechanisms together work towards a stress relief of the core.

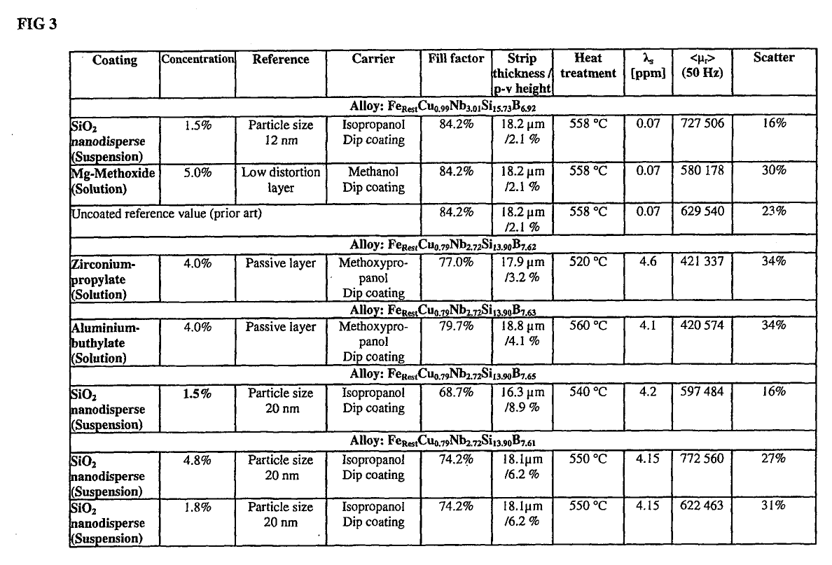

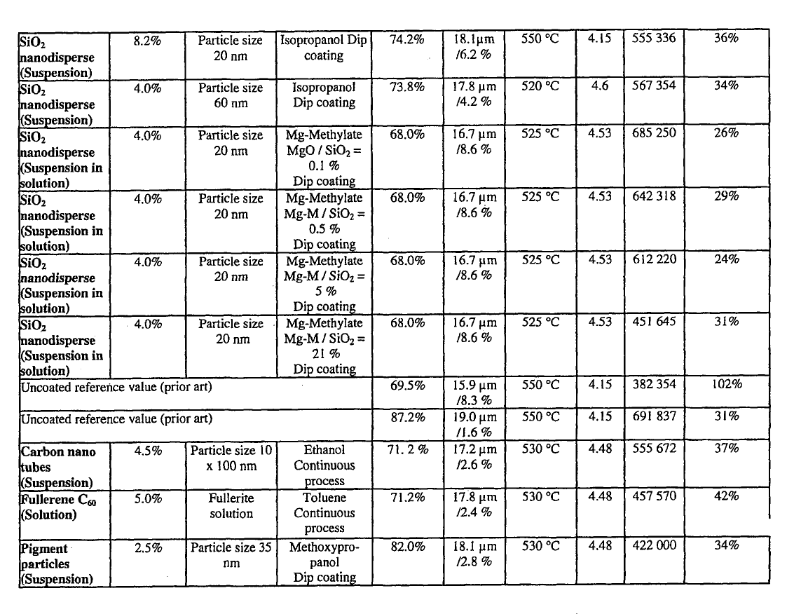

The table of FIG. 3 lists various embodiments. In addition to a coating of nanodisperse SiO₂, MgO, zirconium propylate, aluminium butylate, carbon nano tubes, fullerene and pigment particles were used as static friction reducing materials. Groups of 50-100 cores were coated and heat-treated. Following this, the magnetic properties, in particular the relative permeability μᵣ, were measured at a frequency of 50 Hz. The scatter of the relative permeability is gives as 2a/<μᵣ>, s being the standard deviation.

For comparison, groups of uncoated reference cores were produced using the conventional method. As the table shows, static friction reducing layers of nanodisperse SiO₂, in particular, result in a high relative permeability. Layers of MgO, zirconium propylate or aluminium butylate give low distortion or are largely passive. These layers may however nevertheless enhance the magnetic properties of the magnet cores, because the layer is largely burnt off in the heat treatment process, thereby loosening the core and allowing mechanical stress relief.

Nanodisperse SiO₂ with minor additions of MgO loosens the core by burn-off in the heat treatment process, but the proportion of MgO has to be kept so low that the coating does not have any distorting effect. In this way, the positive effects of the SiO₂ and MgO coatings can be combined.

It has been found that particle size plays a not insignificant role in nanodisperse SiO₂. Tests on finely dispersed SiO₂ with a particle size of 500 nm or 1000 nm respectively indicated a noticeably worsening of magnetic properties, in particular a reduction in permeability to values of approximately 200 000. A slight but not insignificant worsening of magnetic properties can be measured even at a particle size from 60 nm. The concentration of SiO₂ in the dispersion also affects the magnetic properties of the core. Compared to a concentration of 1.5% to 5%, magnetic properties are slightly reduced at a concentration above 8% and even more as concentration increases.

Carbon nano tubes, fullerene and pigment particles do not form any distorting layers. They have a lubricating effect which can be useful in the winding process and in the stress relieving process during the heat treatment of the core.

### REFERENCE NUMBERS

1 Magnet core
2 Strip
3 Strip layer
4 Cylinder
5 Surface
6 Hook
7 Cavity
8 Static friction reducing material
9 Coated surface
10 Intermediate layer
11 Annealing residue

1. A magnet core produced from a spirally wound, soft magnetic strip,
wherein
the soft magnetic strip is provided, on at least one side, with a layer of an annealing residue of a static friction reducing material, so that layers of soft magnetic material and of the annealing residue of a static friction reducing material alternate in the cross-section of the magnet core.

2. The magnet core according to claim 1,
wherein
the soft magnetic strip is nanocrystalline, crystalline, or amorphous.

3. (canceled)

4. (canceled)

5. The magnet core according to claim 1,
wherein
the soft magnetic strip essentially has the composition
FeₐCo_{b}Cu_{c}Si_{d}BₑM_{f},
wherein M represents one or more of the elements V, Nb, Ta, Ti, Mo, W, Zr and Hf, a, b, c, d, e and f are specified in atomic percent and 0≦b≦20; 0.5≦c≦2; 6.5≦d≦18; 5≦e≦14; 1≦f≦6; d+e>16 and a+b+c+d+e+f=100, and wherein cobalt may be partially or wholly replaced by nickel.

6. The magnet core according to claim 1,
wherein
the magnet core has a fill factor of >80% after heat treatment.

7. The magnet core according to claim 1,
wherein
the fill factor η is 70%≦η≦80%.

8. The magnet core according to claim 1,
wherein
the fill factor η is 65%≦η≦70%.

9. The magnet core according to claim 1,
wherein
the magnet core has an effective peak-to-valley height RT of 1%≦RT≦12%.

10. The magnet core according to claim 1,
wherein
the effective peak-to-valley height RT is 1%≦RT≦6%.

11. The magnet core according to claim 1,
wherein
the effective peak-to-valley height RT is 1%≦RT≦4%.

12. The magnet core according to claim 1,
wherein
the magnet core has a magnetostriction constant λ_{S} of λ_{S}<6 ppm.

13. The magnet core according to claim 1,
wherein
the magnet core has a ratio between remanent and saturation flux density B_{R}/B_{S} of B_{R}/B_{S}>40%.

14. The magnet core according to claim 1,
wherein
the magnet core has a ratio between remanent and saturation flux density B_{R}/B_{S} of 1%≦B_{R}/B_{S}≦30%.

15. The magnet core according to claim 1,
wherein
the magnet core has a ratio between remanent and saturation flux density B_{R}/B_{S} of 30%≦B_{R}/B_{S}≦80%.

16. The magnet core according to claim 1,
wherein
the magnet core has a ratio between remanent and saturation flux density B_{R}/B_{S} of 80%≦B_{R}/B_{S}≦97%.

17. The magnet core according to claim 1,
wherein
the static friction reducing material is selected from the group consisting of magnesium methoxide solution, nanodisperse SiO₂, pigment particles, carbon nano tubes, C₆₀ fullerene, aluminum butylate, boron nitride, and zirconium propylate.

18. The magnet core according to claim 1,
wherein
nanodisperse SiO₂ is provided as a static friction reducing material.

19. The magnet core according to claim 18,
wherein
nanodisperse SiO₂ with magnesium methylate is provided as a static friction reducing material.

20. (canceled)

21. (canceled)

22. (canceled)

23. (canceled)

24. A method for the production of a magnet core, comprising the following steps:
provision of an amorphous, soft magnetic strip;
coating of the strip with a static friction reducing material;
winding of the strip to form a magnet core;
heat treatment of the magnet core.

25. A method for the production of a magnet core, comprising the following steps:
provision of an amorphous, soft magnetic strip;
winding of the strip to form a magnet core;
coating of the strip layers representing the magnet core with a static friction reducing material;
heat treatment of the magnet core.

26. The method according to claim 24,
wherein
the heat treatment is conducted field-free in the absence of a magnetic field.

27. The method according to claim 24,
wherein
the heat treatment is conducted at a temperature T of 505° C.≦T≦600° C.

28. The method according to claim 24,
wherein
the static friction reducing material is selected from the group consisting of magnesium methoxide solution, nanodisperse SiO₂, pigment particles, carbon nano tubes, C₆₀ fullerene, aluminum butylate, boron nitride, and zirconium propylate.

29. The method according to claim 24,
wherein
nanodisperse SiO₂ is used as a static friction reducing material.

30. The method according to claim 29,
wherein
nanodisperse SiO₂ with magnesium methylate is used as a static friction reducing material.

31. (canceled)

32. (canceled)

33. (canceled)

34. (canceled)

35. (canceled)

36. (canceled)

37. The method according to claim 24,
wherein
the surface coverage density ρ of the static friction reducing material is 10 mg/m²≦ρ≦600 mg/m².

38. The method according to claim 24,
wherein
the surface coverage density ρ of the static friction reducing material is 20 mg/m²≦ρ≦300 mg/m².

39. The method according to claim 24,
wherein
the surface coverage density ρ of the static friction reducing material is 50 mg/m²≦ρ≦150 mg/m².

40. The method according to claim 24,
wherein
the layer thickness d of the static friction reducing material before heat treatment is d<5 μm.

41. The method according to claim 24,
wherein
the layer thickness d of the static friction reducing material before heat treatment is d<1 μm.

42. The method according to claim 24,
wherein
the layer thickness d of the static friction reducing material before heat treatment is d<0.5 μm.

43. The method according to claim 24,
wherein
the layer thickness d of the static friction reducing material before heat treatment is d<0.2 μm.

44. The method according to claim 24,
wherein
the static friction reducing material is applied by deposition from the gas phase or from a solution.

45. The method according to claim 24,
wherein
the static friction reducing material is applied using the sol gel process.

46. The method according to claim 24,
wherein
the static friction reducing material is applied by solid deposition from a suspension.

47. (canceled)

48. The method according to claim 25,
wherein
the heat treatment is conducted field-free in the absence of a magnetic field.

49. The method according to claim 25,
wherein
the heat treatment is conducted at a temperature T of 505° C.≦T≦600° C.

50. The method according to claim 25,
wherein
the static friction reducing material is selected from the group consisting of magnesium methoxide solution, nanodisperse SiO₂, pigment particles, carbon nano tubes, C₆₀ fullerene, aluminum butylate, boron nitride, and zirconium propylate.

51. The method according to claim 25,
wherein
nanodisperse SiO₂ is used as a static friction reducing material.

52. The method according to claim 51,
wherein
nanodisperse SiO₂ with magnesium methylate is used as a static friction reducing material.

53. The method according to claim 25,
wherein
the surface coverage density ρ of the static friction reducing material is 10 mg/m²≦ρ≦600 mg/m².

54. The method according to claim 25,
wherein
the surface coverage density ρ of the static friction reducing material is 20 mg/m²≦ρ≦300 mg/m².

55. The method according to claim 25,
wherein
the surface coverage density ρ of the static friction reducing material is 50 mg/m²≦ρ≦150 mg/m².

56. The method according to claim 25,
wherein
the layer thickness d of the static friction reducing material before heat treatment is d<5 μm.

57. The method according to claim 25,
wherein
the layer thickness d of the static friction reducing material before heat treatment is d<1 μm.

58. The method according to claim 25,
wherein
the layer thickness d of the static friction reducing material before heat treatment is d<0.5 μm.

59. The method according to claim 25,
wherein
the layer thickness d of the static friction reducing material before heat treatment is d<0.2 μm.

60. The method according to claim 25,
wherein
the static friction reducing material is applied by deposition from the gas phase or from a solution.

61. The method according to claim 25,
wherein
the static friction reducing material is applied using the sol gel process.

62. The method according to claim 25,
wherein
the static friction reducing material is applied by solid deposition from a suspension.
